(19) United States
(12) Patent Application Publication
(10) Pub. No.: US 2014/0185262 A1
(43) Pub. Date: Jul. 3, 2014

(54) STAND FOR ELECTRONIC DEVICE AND ELECTRONIC DEVICE SYSTEM

(71) Applicant: KABUSHIKI KAISHA TOSHIBA, Tokyo (JP)

(72) Inventors: Seiji Hashimoto, Tokyo (JP); Kyohei Matsumoto, Tokyo (JP)

(73) Assignee: KABUSHIKI KAISHA TOSHIBA, Tokyo (JP)

(21) Appl. No.: 14/014,152

(22) Filed: Aug. 29, 2013

Related U.S. Application Data
(63) Continuation of application No. PCT/JP2013/058412, filed on Mar. 22, 2013.

(30) Foreign Application Priority Data
Dec. 28, 2012 (JP) 2012-288487

(51) Int. Cl. F16M 11/00

(52) U.S. Cl. CPC F16M 11/00
USPC 361/809; 248/346.03

(57) ABSTRACT

According to one embodiment, a stand for an electronic device includes a base and a second support. The electronic device includes a housing, a display screen, a first connector, an end at which the first connector is exposed and extended along a periphery of the display screen, and a wall opposite the display screen. The base includes a first support that supports the end of the electronic device, and a second connector electrically connected to the first connector. The second support is pivotably supported by the base between a first position of a lying down posture and a second position of a standing posture, is pivoted from the first position to the second position when the end is moved closer to a support position of the first support so that the second support is pressed by the end, and supports the wall in the standing posture.

### CROSS-REFERENCE TO RELATED APPLICATIONS

This application is a continuation of PCT international application Ser. No. PCT/JP2013/058412 filed on Mar. 22, 2013 which designates the United States, incorporated herein by reference, and which claims the benefit of priority from Japanese Patent Application No. 2012-288487, filed on Dec. 28, 2012, the entire contents of which are incorporated herein by reference.

### FIELD

Embodiments described herein relate generally to a stand for an electronic device, and an electronic device system.

### BACKGROUND

Conventionally, there is known a stand that detachably supports an electronic device in a standing posture by a movable support portion.

In this type of the device, as an example, it is preferred that the electronic device can be easily stood on the stand.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention;

FIG. 1 is an exemplary front view of one example of an electronic device according to an embodiment;

FIG. 2 is an exemplary side view of one example of the electronic device in the embodiment;

FIG. 3 is an exemplary schematic view of an internal configuration of one example of the electronic device in the embodiment;

FIG. 4 is an exemplary perspective view of a state in which one example of the electronic device is supported by a stand, in the embodiment;

FIG. 5 is an exemplary perspective view of one example of the stand in a state in which a second support portion is at a first position, in the embodiment;

FIG. 6 is an exemplary perspective view of one example of the stand in a state in which the second support portion is at a third position, in the embodiment;

FIG. 7 is an exemplary perspective view of one example of the stand in a state in which the second support portion is at a fourth position, in the embodiment;

FIG. 8 is an exemplary perspective view of a base of one example of the stand in the embodiment;

FIG. 9 is an exemplary perspective view of one example of the second support portion included in the stand, in the embodiment;

FIG. 10 is an exemplary perspective view of one example of the second support portion comprised in the stand when viewed at a line of sight different from FIG. 9, in the embodiment;

FIG. 11 is an exemplary cross-sectional view illustrating a state before the electronic device is attached to one example of the stand taken along a line XI-XI of FIG. 5, in the embodiment;

FIG. 12 is an exemplary cross-sectional view illustrating a state in which a housing begins to press the second support portion when the electronic device is attached to one example of the stand taken along the line XI-XI of FIG. 5, in the embodiment;

FIG. 13 is an exemplary cross-sectional view illustrating a state in which the second support portion pressed against the housing is located at a second position when the electronic device is attached to one example of the stand taken along the line XI-XI of FIG. 5, in the embodiment.

FIG. 14 is an exemplary cross-sectional view illustrating a state in which the electronic device is attached to one example of the stand taken along the line XI-XI of FIG. 5, in the embodiment;

FIG. 15 is an exemplary cross-sectional view of the stand taken along the line XI-XI of FIG. 5 in a state in which the second support portion of one example of the stand is at a first position, in the embodiment;

FIG. 16 is an exemplary cross-sectional view of the stand taken along the line XI-XI of FIG. 5 in a state in which the second support portion of one example of the stand is at a fourth position, in the embodiment;

FIG. 17 is an exemplary perspective view of one example of a stand in a state in which the second support portion is at a third position, according to a modification of the embodiment; and

FIG. 18 is an exemplary cross-sectional view of the stand taken along the line XI-XI of FIG. 5 in a state in which the second support portion of one example of the stand is at the third position, in the modification of the embodiment.

### DETAILED DESCRIPTION

In general, according to one embodiment, a stand for an electronic device comprises a base and a second support portion. The electronic device comprises a housing, a display screen, a first connector, an end of the housing at which the first connector is exposed and extended along a periphery of the display screen, and a wall of the housing opposite the display screen. The base comprises a first support portion configured to support the end of the electronic device, and a second connector configured to be electrically connected to the first connector. The second support portion is configured to be pivotably supported by the base between a first position of a lying down posture and a second position of a standing posture, to be pivoted from the first position to the second position when the end is moved closer to a support position of the first support portion so that the second support portion is pressed by the end, and to support the wall in the standing posture.

In the following exemplary embodiments and modifications, the same components are included. Therefore, in the following, the same reference numerals will be assigned to the same components, and a redundant description thereof will be partially omitted.

Also, in the following embodiments and modifications, a case where the electronic device is configured as a personal computer is exemplified, but the electronic device according to the embodiment is not limited thereto. The electronic device according to the embodiment may be configured as a variety of electronic devices, for example, a smartphone or a portable phone, a personal digital assistant (PDA), an electronic dictionary device, a video display device, a video phone, and a display device with a soft keyboard.

### EMBODIMENT

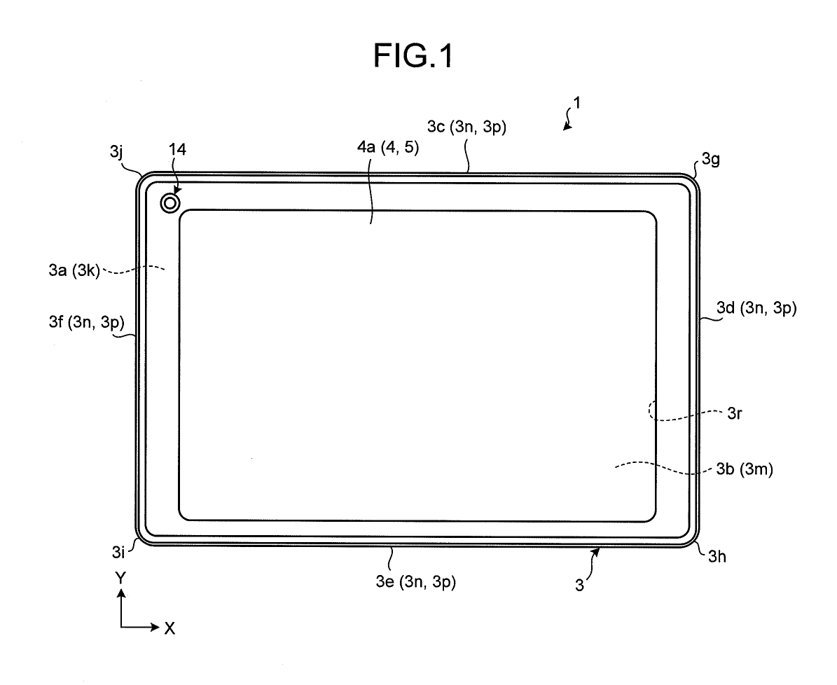

In FIGS. 1 to 3, for convenience, directions (X direction, Y direction, and Z direction) are illustrated. The X direction is a longitudinal direction in a front view of a display screen 4a, the Y direction is a transverse direction in the front view of the display screen 4a, and the Z direction is a forward direction (thickness direction of a housing 3) in the front view of the display screen 4a. The X direction, the Y direction, and the Z direction are orthogonal to one another.

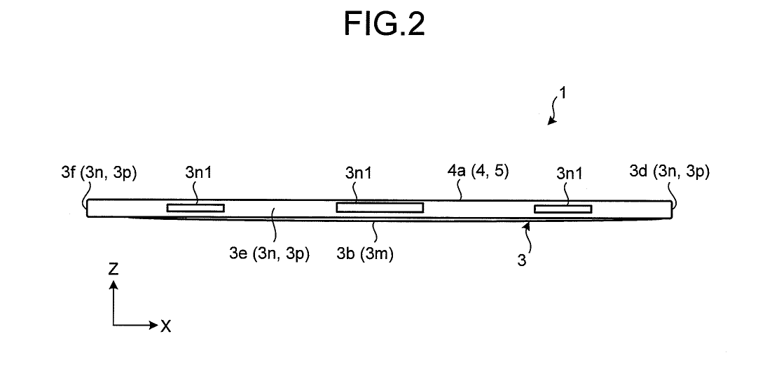

In the present embodiment, as an example, as can be seen from FIGS. 1, 2 and the like, the housing 3 of an electronic device 1 presents an outer appearance of a quadrangular shape (a rectangular shape as an example in the present embodiment) in the front view and the rear view. Also, the housing 3 is configured in a thin flat rectangular parallelepiped shape in a front-back direction (thickness direction of the housing 3, Z direction). The housing 3 has a face 3a (front face, forward face, surface, face portion) and an opposite face 3b (rear face, backward face, back face, face portion). The face 3a and the face 3b are provided in a posture facing opposite sides (in parallel as an example in the present embodiment). In the front view, the housing 3 has four ends 3c to 3f (sides, edges) and four corners 3g to 3j (apex portions, curved portions, edge portions). The ends 3c and 3e are an example of long side portions. The ends 3d and 3f are an example of short side portions. Also, the housing 3 has four faces 3p (side faces, face portions) disposed over between the face 3a and the face 3b. Also, the plurality of faces 3p need not be clearly separated, and may be smoothly connected through bent portions or the like. Also, in the following, for convenience, an upper side of FIG. 2 (direction normal to the display screen 4a) will be referred to as a front side, and a lower side of FIG. 2 (side opposite to the front side) will be referred to as a rear side.

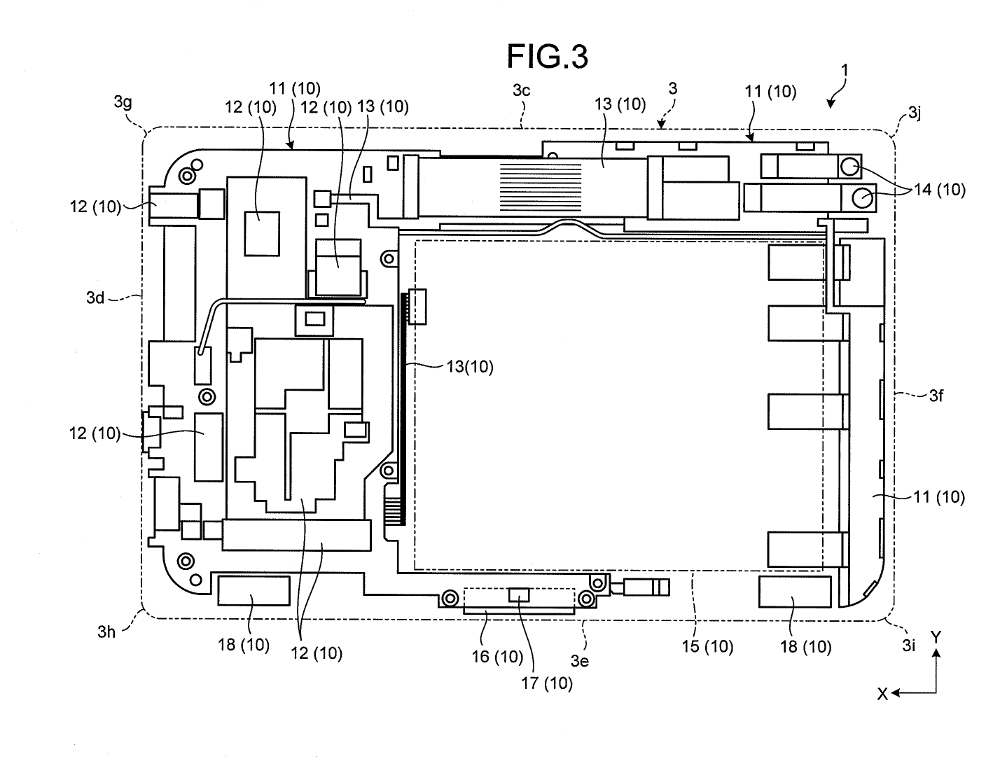

Also, the housing 3 has a wall 3k (part, plate, frame, front wall, forward wall, fore wall, top wall) disposed on the front side, and a wall 3m (part, plate, rearward wall, back ball, bottom wall) disposed on the rear side. The walls 3k and 3m have a quadrangular shape (a rectangular shape as an example in the present embodiment). In the wall 3k, a quadrangular opening 3r is provided. Therefore, the wall 3k has a quadrangular frame shape. The display screen 4a of a display device 4 is covered with a transparent portion of a touch panel 5 (touch sensor, input operation panel). The display screen 4a is visible through an opening 3r. The wall 3k surrounds the display device 4. The wall 3m has a quadrangular plate shape. The wall 3m covers a back face (not illustrated) disposed opposite the display screen 4a of the display device 4. Also, the housing 3 has four walls 3n (parts, plate, sidewalls, end walls, upstanding walls, extending portions) disposed over between the wall 3k and the wall 3m. The walls 3n intersect with the walls 3m and cover the corresponding side along the side (not illustrated) of the display device 4. Also, the walls 3m and the walls 3n need not be necessarily separated clearly from one another, and may be smoothly connected through bent portions or the like. The cross-sections of the walls 3m and the walls 3n may have an arc shape. The walls 3k and the walls 3n also need not be necessarily separated clearly from one another, and may be smoothly connected through bent portions or the like. The cross-sections of the walls 3k and the walls 3n also may have a series of arc shapes. Also, as illustrated in FIG. 2, openings 3n1 exposing connectors or switches (operation unit) are provided in the walls 3n. In the present embodiment, as an example, the central opening 3n1 among three openings 3n1 illustrated in FIG. 2 is an opening for a connector 16 (first connector, see FIG. 3), and the openings 3n1 on both sides are openings for a speaker module 18. The walls 3k and 3m are widened substantially along an XY plane. Also, the housing 3 may have walls (parts, plates, frames, middle walls, inner walls, middle plates, middle frames, third walls, not illustrated) disposed between the walls 3k and the walls 3m.

Also, in the present embodiment, as an example, the housing 3 may be configured by a combination of a plurality of members (housing members, parts, partition bodies). Examples of the members constituting the housing 3 may be a synthetic resin material (plastics, engineering plastics, or the like) or a metal material (aluminum alloy, magnesium alloy, stainless steel, or the like).

Also, in the present embodiment, as an example, at least a portion of the display device 4 (display unit, display, panel, display component) is received within the housing 3. A user can view the display screen 4a from the front side (forward side) through the opening 3r. The display device 4 presents an outer appearance of a quadrangular shape (a rectangular shape as an example in the present embodiment) in the front view. Also, the display device 4 is configured in a thin flat rectangular parallelepiped shape in a front-back direction (Z direction, thickness direction of the housing 3). The display device 4 may be, for example, a liquid crystal display (LCD) or an organic electro-luminescent display (OELD). Also, the display device 4 may be a flexible display. Also, the touch panel 5 may be configured as an in-cell touch panel embedded in the display device 4.

Also, in the present embodiment, as an example, as illustrated in FIG. 3, electric components 10 (components), such as a circuit board 11 (substrate, print board, control board), wires 13 (cable, harness, flexible cable, flexible printed wiring board, or the like), a camera module 14 (camera unit, camera assembly, camera, image pickup device), a battery module 15 (battery, assembled battery, cell, module, battery pack, battery unit), the connector 16 (connector unit, connector assembly, connector module, connector device, connection portion, coupling portion), a motion sensor 17 (motion sensor module, motion detection unit), and the speaker module 18 (speaker unit, speaker assembly, speaker, audio output device), are included in the rear side (back side, backward side, wall 3m side, side opposite to the display screen 4a) of the display device 4 within the housing 3. These electric components are electrically connected to other electric components through the wires 13. Also, although not illustrated, a vibration generation unit (for example, a motor with an eccentric weight attached on a rotational shaft) or the like may be received within the housing 3. Also, as the electric components 10, various components 12 (electronic components, devices, chips, packages, or the like) are provided (mounted) in the circuit board 11.

In the present embodiment, as an example, the battery module 15 may be configured as a lithium-ion secondary battery. In the present embodiment, as an example, in addition to the display device 4, source power necessary for the electronic device 1 to perform an operation of displaying images or outputting audio may be supplied to the electric components equipped in the housing 3 through the wires 13 or the like. Also, the battery module 15 may supply power to external devices electrically connected to the circuit board 11 or the like through the wires 13, a conductor portion (bus bar, not illustrated), the connector 16, or the like. Also, in the present embodiment, as an example, the battery module 15 presents an outer appearance of a quadrangular shape in the front view or the rear view, and presents a thin flat shape in the thickness direction of the housing 3. Also, in the present embodiment, as an example, the battery module 15 is provided at a position close to the end 3e rather than the end 3c.

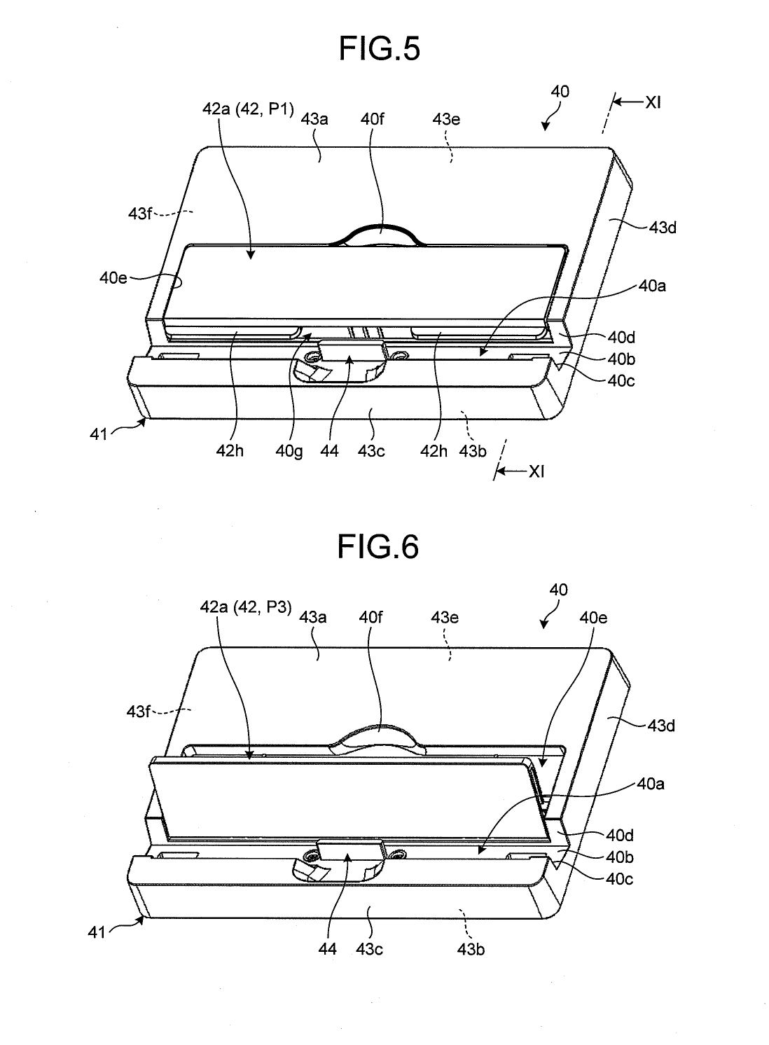

In the present embodiment, as an example, the connector 16 is electrically connected to other connector module (for example, a connector 44 of a stand 40, see FIG. 5 or the like) so as to establish electrical connection with respect to external electronic device. The connector 16 is provided closer to the end 3e within the housing 3. Also, in the present embodiment, as an example, the connector 16 is provided (mounted) to the circuit board 11. Also, the circuit board 11 where the connector 16 is provided may be configured separately from the circuit board 11 where other components 12 are provided.

In the present embodiment, as an example, a plurality of components 12, for example, a central processing unit (CPU), a graphic controller, a power supply circuit component, a platform controller hub (PCH), a memory slot connector, an LCD connector, an input/output (I/O) connector, a power coil, devices, or a connector, may be mounted on the circuit board 11.

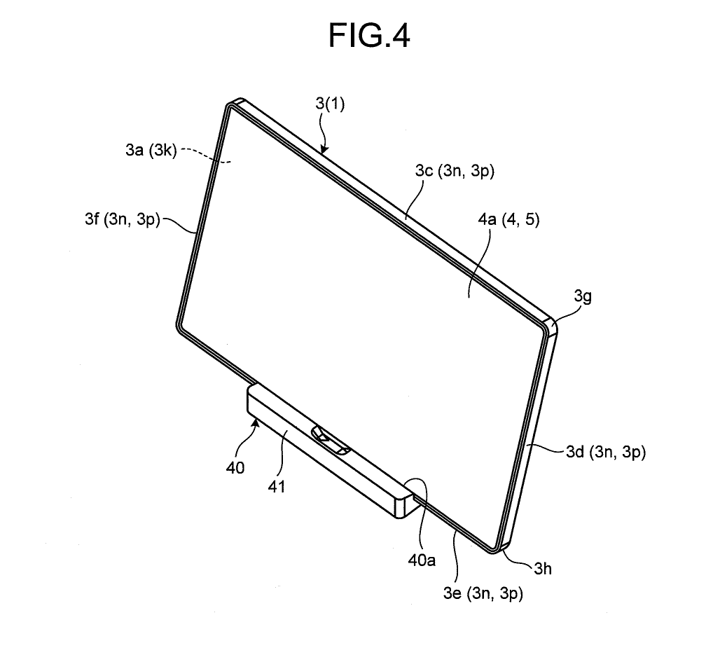

Also, in the present embodiment, as an example, the electronic device 1 is detachably supported by the stand 40 (support portion, expansion device, dock, docking station, cradle) illustrated in FIGS. 4 to 10. The stand 40 supports the end 3e of the housing 3 of the electronic device 1. The stand 40 is provided with a recess 40a (groove) opened to a side (upper side) away from a placement face P, and the end 3e is received within the recess 40a. That is, in the present embodiment, faces 40b to 40d (walls, a portion of a base 41, see FIG. 5) constituting the recess 40a are one example of a first support portion. The electronic device 1 is directed from the end 3e disposed in the placement face P side (lower side) to the end 3c disposed in the side (upper side) away from the placement face P. Thus, the electronic device 1 is supported by the stand 40 in a backward tilted posture directed toward the rear side.

The stand 40 includes the base 41 (base, fixing portion) and a movable portion 42. The base 41 presents an outer appearance of a flat rectangular parallelepiped shape along the placement face P. The base 41 includes a housing 43. A circuit board (circuit board assembly) where electronic components (electrical components, components) are mounted, or electric components or the like (all not illustrated) which are not mounted on the corresponding circuit board may be received within the housing 43. The housing 43 has a face 43a (upper face, top wall, wall), a face 43b (lower face, bottom wall, wall), and faces 43c to 43f (sides, side walls, walls, ends). The recess 40a extends linearly along the corresponding face 43c at a position close to the face 43c.

Also, in the present embodiment, as an example, as illustrated in FIGS. 5 and 6, the connector 44 (second connector, connector unit, connector assembly, connector module, connector device, connection portion, coupling portion) protrudes at a central position (middle position) of the recess 40a in a longitudinal direction. The connector 44 is electrically connected to the connector 16 (first connector) of the electronic device 1. Also, the connector 44 may be electrically connected to the circuit board provided within the housing 43 or a plurality of other connectors (not illustrated). Also, the plurality of other connectors may be exposed at a face 43d of the housing 43 (not illustrated) and may be electrically connected to other external connectors. That is, the stand 40 may serve as an expansion device.

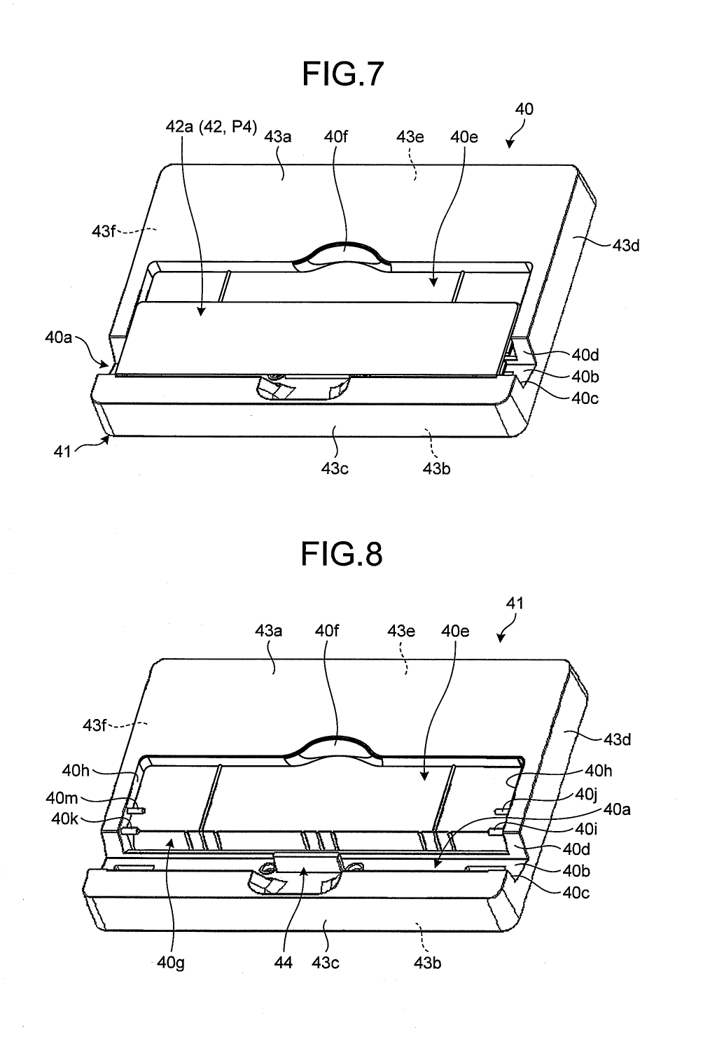

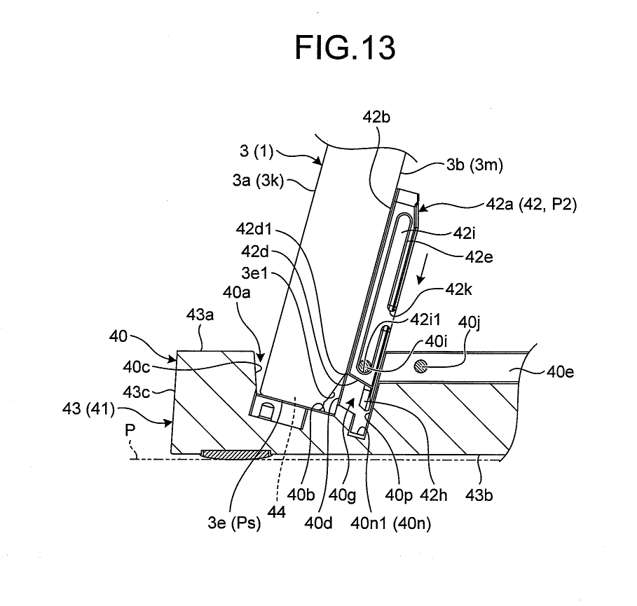

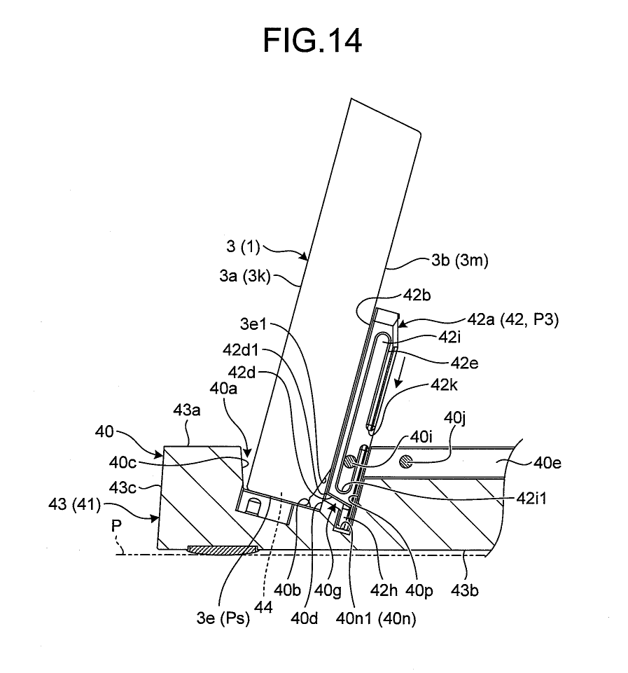

Also, in the present embodiment, as an example, the movable portion 42 is supported to the base 41 movably among a first position P1 illustrated in FIGS. 5, 11 and 15, a second position P2 illustrated in FIG. 13, a third position P3 illustrated in FIGS. 6 and 14, and a fourth position P4 illustrated in FIGS. 7 and 16. Also, the movable portion 42 may be supported in a stationary condition at each of the first position P1, the third position P3, and the fourth position P4.

Also, in the present embodiment, as an example, as illustrated in FIGS. 5 to 8, a recess 40e presenting an outer appearance of a rectangular shape in the plan view and having a substantially constant depth is provided on the face 43a of the housing 43. As illustrated in FIG. 5, the movable portion 42 (wall 42a) is received in the recess 40e at the first position P1. That is, the recess 40e is one example of a receiving portion of the movable portion 42 (wall 42a). Also, in a state in which the movable portion 42 is received in the recess 40e, a face 42b of the movable portion 42 and the face 43a of the housing 43 are substantially continuous. Also, a recess 40f is provided on a side away from the recess 40a of the recess 40e. A user can put his/her finger in the recess 40f and move the movable portion 42 from the first position P1 to the fourth position P4.

Also, in the present embodiment, as an example, as illustrated in FIG. 8, a recess 40g presenting an outer appearance of a rectangular shape in the front view and having a substantially constant depth is provided on the face 40d of the recess 40a. As illustrated in FIG. 6, the movable portion 42 (wall 42a) is received in the recess 40g at the third position P3. That is, the recess 40g is one example of a receiving portion of the movable portion 42 (wall 42a).

At the first position P1 illustrated in FIGS. 5, 11 and 15, the movable portion 42 (wall 42a) is located at a side (rear side, back side) opposite the face 43c of the recess 40a in a lying down posture (prone posture), and is received within the recess 40e. In this state, the recess 40a and the connector 44 are exposed to the side (upper side) opposite to the placement face P. Therefore, the end 3e of the electronic device 1 may be inserted (plugged) into the recess 40a. That is, at the first position P1, the movable portion 42 is in an open state to open the recess 40a and the connector 44, and is in a standby state capable of receiving the electronic device 1.

At the third position P3 illustrated in FIGS. 6 and 14, the movable portion 42 (wall 42a) is located on the side (rear side, back side) opposite the face 43c of the recess 40a in a standing posture (upright posture). The movable portion 42 may support the electronic device 1 at the third position P3. In a state of supporting the housing 3, the movable portion 42 supports the wall 3m of the housing 3. The movable portion 42 is one example of the second support portion.

At the fourth position P4 illustrated in FIGS. 7 and 16, the movable portion 42 (wall 42a) is located the front side within the recess 40e in a lying down posture (prone posture) and covers the recess 40a and the connector 44. In a state in which the movable portion 42 is located at the fourth position P4, the electronic device 1 cannot be mounted on the stand 40. That is, the movable portion 42 is in a closed state (coated state, suppressed state) to cover the recess 40a and the connector 44 at the fourth position P4.

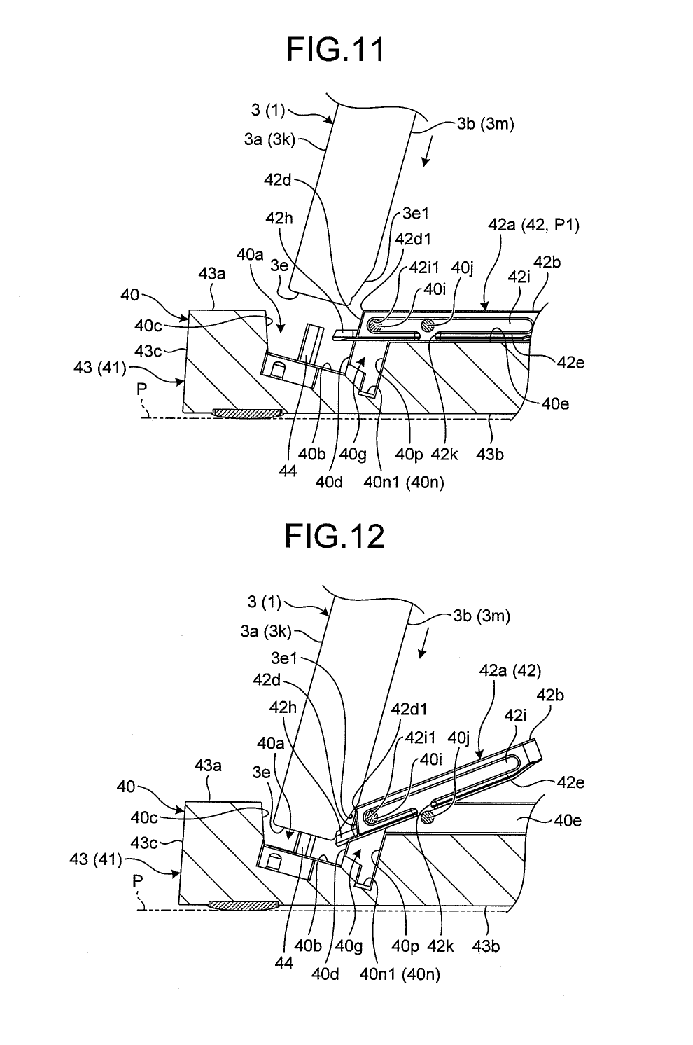

Also, in the present embodiment, as an example, as illustrated in FIG. 8, two shafts 40i and 40j (support portions, protrusion portions, protrusions, shafts) and two shafts 40k and 40m (support portions, protrusion portions, protrusions, shafts) are provided, at intervals, on two opposite faces 40h (inner faces) of the recess 40e in the longitudinal direction of the recess 40a (longitudinal direction of the end 3e of the housing 3 of the electronic device 1 to be mounted). All the four shafts 40i, 40j, 40k and 40m extend along the longitudinal direction of the recess 40a. Also, each of the two shafts 40i and 40k facing each other is disposed in a straight line along the longitudinal direction of the recess 40a. Also, each of the two shafts 40j and 40m facing each other is disposed in a straight line along the longitudinal direction of the recess 40a. The shafts 40j and 40m are spaced in the rear of the shafts 40i and 40k. Also, as illustrated in FIGS. 11 to 16, the shafts 40i and 40j are disposed in the front side within the recess 40e and the upper side within the recess 40g.

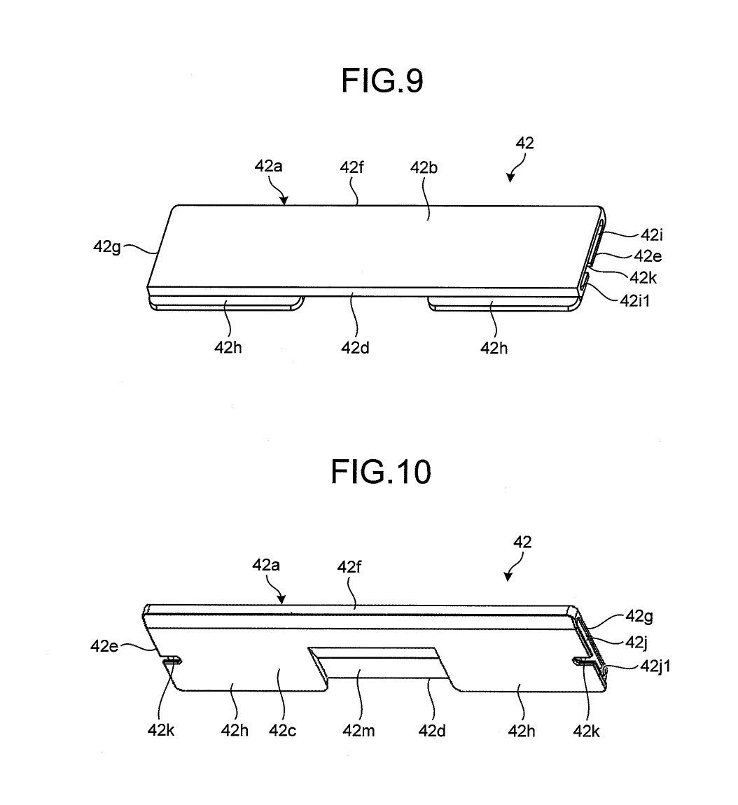

Also, in the present embodiment, as an example, as illustrated in FIGS. 9 and 10, the movable portion 42 is configured in a quadrangular shape (a rectangular shape as an example in the present embodiment) and a plate shape. The wall 42a of the movable portion 42 has the face 42b, a face 42c, and ends 42d to 42g. In the end 42d, a protrusion 42h (wall) having a constant width and protruding from the face 42c on a side opposite an end 42f is provided. The protrusion 42h is pressed against the end 3e of the housing 3 of the electronic device 1. The protrusion 42h is one example of a pressing portion (receiving portion, arm portion).

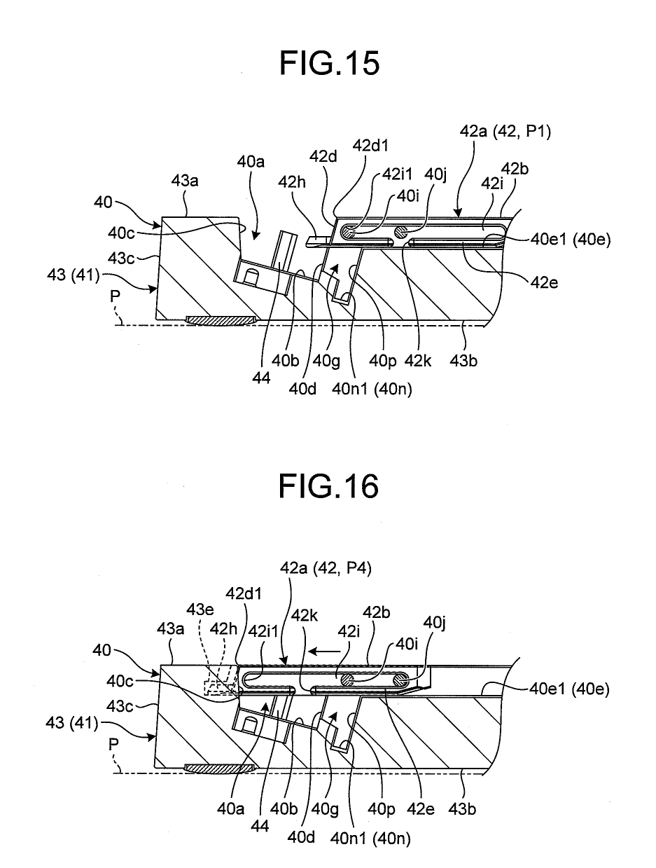

Also, in the present embodiment, as an example, grooves 42i and 42j (recesses) opened laterally (direction perpendicular to ends 42e and 42g and along the faces 42b and 42c) are provided in the ends 42e and 42g of the wall 42a (movable portion 42). The grooves 42i and 42j extend along the ends 42e and 42g. The grooves 42i and 42j have a mirror image relationship. The shafts 40i and 40j are received in the groove 42i, and the shafts 40k and 40m are received in the groove 42j. When the movable portion 42 moves (slides) in a lying down posture between the first position P1 and the fourth position P4 (see FIGS. 15 and 16), the shafts 40i and 40j relatively move along the groove 42i. Although not illustrated in FIGS. 15 and 16, the shafts 40k and 40m also relatively move along the groove 42j. That is, in the present embodiment, regarding the movement of the movable portion 42 between the first position P1 and the fourth position P4, the shafts 40i, 40j, 40k and 40m are one example of a slider (movable support portion), and the grooves 42i and 42j are one example of a rail.

Also, in the present embodiment, as an example, when the movable portion 42 moves (slides) between the second position P2 and the third position P3 in a standing (backward tilted) posture as it is (see FIGS. 13 and 14), the shaft 40i relatively moves along the groove 42i. Although not illustrated in FIGS. 13 and 14, the shaft 40k also relatively moves along the groove 42j. That is, in the present embodiment, regarding the movement of the movable portion 42 between the second position P2 and the third position P3, the shafts 40i and 40k are one example of a slider (movable support portion), and the grooves 42i and 42j are one example of a rail.

Also, in the present embodiment, as an example, when the movable portion 42 pivots (moves) between the first position P1 and the second position P2 (see FIGS. 11 to 13), the shaft 40i maintains a state of being located at an end 42i1 of the front side of the groove 42i. Although not illustrated in FIGS. 11 to 13, the shaft 40k also maintains a state of being located at an end 42j1 of the groove 42j (see FIG. 10). The movable portion 42 pivots around the shafts 40i and 40k. That is, in the present embodiment, regarding the pivoting (movement) of the movable portion 42 between the first position P1 and the second position P2, the shafts 40i and 40k are one example of a pivot support portion that pivotably supports the movable portion 42. In the present embodiment, the shafts 40i and 40k are one example of a fifth support portion.

Also, in the present embodiment, as an example, as illustrated in FIGS. 9 and 10, openings 42k (notch) connected to the grooves 42i and 42j are provided to the face 42c side of the ends 42e and 42g of the movable portion 42. As illustrated in FIGS. 12 and 13, when the movable portion 42 (wall 42a) pivots, the shaft 40j passes through the opening 42k connected to the groove 42i. Although not illustrated in FIGS. 12 and 13, the shaft 40m also passes through the opening 42k connected to the groove 42j. In this manner, the movable portion pivots. That is, the openings 42k are located at the lower sides of the shafts 40j and 40m (placement face P side, opposite side to the second position P2) in a state in which the shaft 40i abuts against the end 42i1 of the groove 42i and the shaft 40k abuts against the end 42j1 of the groove 42j. Since the openings 42k are provided at only these positions, the movable portion 42 cannot pivot in a state in which the movable portion 42 is located at positions other than the first position P1.

Also, in the present embodiment, as an example, as illustrated in FIG. 10, a recess 42m is provided on the face 42c of the movable portion 42 (wall 42a). The recess 42m suppresses interference with the connector 44 in a state in which the movable portion 42 is located at the fourth position P4.

Also, in the present embodiment, as an example, as illustrated in FIG. 12, the end 3e of the housing 3 of the electronic device 1 presses the protrusion 42h of the movable portion 42 when lowering toward a support position Ps of the recess 40a (see FIG. 13). A force applied from the end 3e to the movable portion 42 (wall 42a) moves the protrusion 42h downward, while pressing the movable portion 42 against the shaft 40i (40k), and pivots (moves, flips up) the movable portion 42 in a counterclockwise direction of FIG. 12.

Herein, in the present embodiment, as an example, as illustrated in FIGS. 11 and 12, an inclined face 3e1 (inclined portion) is provided in the end 3e. The end 3e may move toward the support position Ps in a state in which the inclined face 3e1 and a corner 42d1 of the end 42d of the movable portion 42 contact each other, that is, while being guided to the corner 42d1. Therefore, in the present embodiment, the corner 42d1 is one example of a guide portion. Also, the corner 42d1 provided in the movable portion 42 is located at a side of the protrusion 42h opposite the support position Ps. Therefore, even when the end 3e of the housing 3 is entered into the recess 40a at a position slightly shifted to the rear side (right side in FIGS. 11 and 12), the end 3e (the inclined face 3e1 as an example in the present embodiment) hit against the corner 42d1 and is guided to the support position Ps side of the front side. Also, the movable portion 42 is supported movably from the first position P1 to the front side (left side in FIGS. 11 and 12) in the shaft 40i (base 41). However, since a backward force is applied from the end 3e to the movable portion 42, the force applied from the end 3e suppresses the forward movement of the movable portion 42 when the end 3e is moved to the support position Ps. Also, the movable portion 42 received in the recess 40e at the first position P1 cannot be moved more rearward than the first position P1 and cannot be moved (pivoted) downward. Therefore, the movable portion 42 is easily pivoted toward the second position P2 by the force applied from the end 3e. Also, the protrusion 42h is located close to the face 42c to a thinner thickness than the wall 42a. Thus, a height difference is provided in the side (upper side) abutting against the end 3e of the end 42d. Therefore, as an example, as compared with a case where the protrusion 42h protrudes without height difference from the face 42b, it is easy to determine a position pressed by the end 3e.

After the states of FIGS. 11 and 12, as illustrated in FIG. 13, the end 3e of the housing 3 is located at the support position Ps, and the movable portion 42 (wall 42a) is moved (pivoted) to the second position P2. Next, as illustrated in FIG. 14, since the third position P3 is set to a position lower than the second position P2, the movable portion 42 is moved from the second position P2 to the third position P3 by the gravity applied to the movable portion 42. Therefore, according to the present embodiment, as an example, the movable portion 42 is rapidly or more reliably transferred according to the state of supporting the housing 3. Also, FIGS. 13 and 14 exemplarily illustrate the case where the movable portion 42 is moved from the second position P2 to the third position P3 after the end 3e is moved to the support position Ps, but this is only for illustrative purposes. For example, the movable portion 42 may be moved from the second position P2 to the third position P3 by a friction (connection) between the end 3e and the movable portion 42 according to the movement of the end 3e to the support position Ps. In this case, the end 3e (housing 3) is guided to the support position Ps by the movable portion 42 moving from the second position P2 to the third position P3. That is, in this case, the movable portion 42 functions as a guide portion.

Also, in the present embodiment, as an example, as illustrated in FIG. 14, a recess 40n is provided at the end of the lower side of the recess 40g in the base 41. The protrusion 42h (end 42d) of the movable portion 42 (wall 42a) located at the third position P3 is received in the recess 40n. That is, in the present embodiment, a face 40n1 (inner face) constituting the recess 40n is one example of the third support portion (receiving portion, holding portion, supporting portion). Therefore, according to the present embodiment, as an example, it is easy to more stably hold the movable portion 42 at the third position P3. Therefore, as an example, it is easy to more stably hold the housing 3 in a standing posture.

Also, in the present embodiment, as an example, as illustrated in FIG. 14, the base 41 has a face 40p (inclined face) that is a portion of the face of the recess 40g. The movable portion 42 (wall 42a) located at the third position P3 is supported by the base 41 in a state in which the movable portion 42 is interposed between the housing 3 and the face 40p. That is, in the present embodiment, the face 40p is one example of the fourth support portion. Therefore, in the present embodiment, as an example, it is easy to more firmly hold the movable portion 42 and the housing 3 as compared with the case where the movable portion 42 is held to only the face 40n1 of the recess 40n.

Also, in the present embodiment, as an example, as illustrated in FIGS. 15 and 16, the movable portion 42 (wall 42a) may be moved between the first position P1 and the fourth position P4 in a lying down posture as it is. The movable portion 42 may be moved between the first position P1 and the fourth position P4 along a face 40e1 (bottom face) of the recess 40e by a force applied from a user's finger or the like. Also, at the fourth position P4, the protrusion 42h is received in a recess 43e provided in the face 40c, and the protrusion 42h and the movable portion 42 are supported by the face (wall) constituting the recess 43e.

As described above, in the present embodiment, as an example, the movable portion 42 (wall 42a, second support portion) are pivotably supported by the base 41 (base portion) between the first position 21 of the lying down posture and the second position P2 of the standing posture. Also, the movable portion 42 may be pressed by the end 3e moving to come closer to the support position Ps by the base 41, and may be pivoted from the first position P1 to the second position P2. Therefore, according to the present embodiment, as an example, the movable portion 42 can be more easily pivoted from the first position P1 to the second position P2. Therefore, as an example, a user can more easily move the movable portion 42 in a state in which the housing 3 is supported in a standing state.

Also, in the present embodiment, as an example, the movable portion 42 is movably supported to the base 41 between the second position P2 and the third position P3. Therefore, according to the present embodiment, as an example, the movable portion 42 may be more easily moved to the third position P3 that is different from the second position P2 at which the posture is more unstable. Therefore, as an example, it is easy to firmly hold the housing 3 by the base 41. Also, in the present embodiment, as an example, the movable portion 42 is movably supported by the base 41 between the second position P2 and the third position P3 along the direction of moving to the support position Ps of the end 3e of the housing 3. Therefore, according to the present embodiment, as an example, the movable portion 42 may function as a guide portion that moves with the end 3e. Therefore, as an example, the housing 3 is easily mounted on the stand 40 more reliably.

Also, in the present embodiment, as an example, the base 41 includes the shafts 40i and 40k that pivotably support the movable portion 42 between the first position 21 and the second position P2, and pivotably support the movable portion 42 between the second position P2 and the third position P3. Therefore, according to the present embodiment, as an example, the configuration that the movable portion 42 moves among the first position P1, the second position P2, and the third position P3 is easily obtained as a relatively simple configuration.

Also, in the present embodiment, as an example, the movable portion 42 includes the protrusion 42h (press portion) that is located closer to the support position Ps than the position where the end 3e is guided to the corner 42d1 (guide portion) and is pressed to the end 3e. Also, in the present embodiment, as an example, the movable portion 42 includes the corner 42d1 (guide portion) that guides the movement of the end 3e in a state of being located at the first position P1. Therefore, according to the present embodiment, as an example, it is easy for the end 3e of the housing 3 to press the protrusion 42h more reliably. Also, the guide portion may also be provided in the base 41, for example, by configuring the face 40c as the guide portion.

Also, in the present embodiment, as an example, the movable portion 42 is movably supported to the base 41 between the first position P1 and the fourth position P4 of the lying down posture covering the connector 44. Therefore, according to the present embodiment, as an example, the connector 44 may be covered by the movable portion 42.

### MODIFICATION

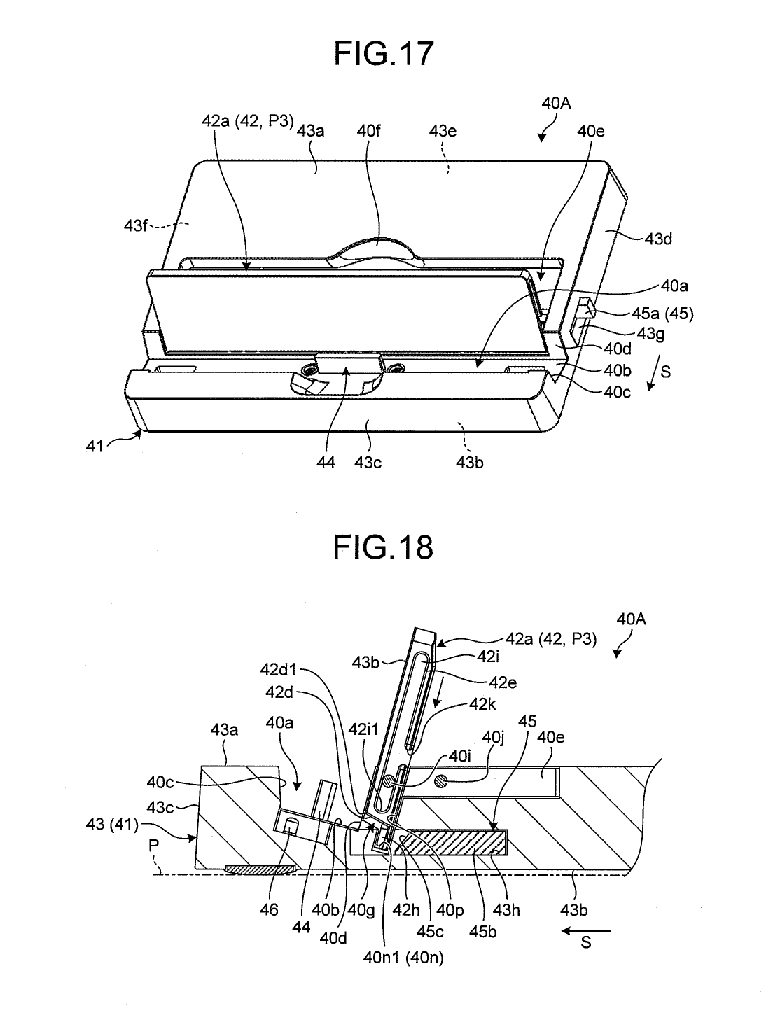

A stand 40A according to a modification illustrated in FIGS. 17 and 18 has the same configuration as the stand 40 according to the embodiment. Therefore, even in the present modification, the same result (effect) based on the same configuration as the embodiment is obtained. However, in the present modification, an eject mechanism 45 (moving mechanism, moving device) is provided to move the movable portion 42 from the third position P3 to the second position P2. Specifically, in the present modification, as an example, as illustrated in FIG. 17, an opening 43g is provided on the face 43d of the housing 43. A lever 45a (handle, knob) protrudes from the opening 43g. The opening 43g extends along the longitudinal direction (front-back direction) of the face 43d, and the lever 45a is configured to be movable (reciprocating) along the longitudinal direction of the face 43d. Also, a slider 45d that is (integrally) movable in conjunction with the lever 45a is received in the base 41. A slider 45b is movably (reciprocatingly) received in a recess 43h provided within the housing 43 of the base 41. A inclined face 45c pressing the end 42d (protrusion 42h) of the movable portion 42 is provided in the slider 45b. Therefore, according to the present modification, as an example, the movable portion 42 may be lifted more higher than the position P3 by moving the lever 45a. Also, the slider 45b may interlock with a press portion 46 (movable portion, pin, protrusion portion) pushing up the end 3e of the housing 3. As an example, the press portion 46 is connected to the slider 45b through a link mechanism or a cam mechanism (not illustrated). In this case, a user can push up the housing 3 of the electronic device 1 together with the movable portion 42 by moving the slider 45b in a direction of arrow S of FIGS. 17 and 18.

While certain embodiments have been described, these embodiments have been presented by way of example only, and are not intended to limit the scope of the inventions. The embodiments and modifications described herein may be embodied in a variety of other forms; furthermore, various omissions, substitutions and changes may be made without departing from the essentials of the inventions. The embodiments and modifications fall within the scope or essentials of the inventions and also fall within the inventions described in claims and their equivalents. Also, components can be partially replaced between the embodiments and the modifications. Also, specification of each component (structure, type, direction, shape, size, length, width, thickness, height, number, arrangement, position, material, and the like) can be appropriately modified. As an example, the stand may be configured such that the shaft (slider, protrusion portion) is provided in the movable portion (second support portion), and the groove (rail) movably guiding the shaft is provided in the base (base). Also, the stand may include an elastic member that elastically presses the second support portion in a predetermined direction. The accompanying claims and their equivalents are intended to cover such forms or modifications as would fall within the scope and spirit of the inventions.

What is claimed is:

1. A stand for an electronic device, the electronic device comprising a housing, a display screen, a first connector, an end of the housing at which the first connector is exposed and extended along a periphery of the display screen, and a wall of the housing opposite the display screen, the stand comprising:
a base comprising a first support portion configured to support the end of the electronic device, and a second connector configured to be electrically connected to the first connector; and
a second support portion configured to be pivotably supported by the base between a first position of a lying down posture and a second position of a standing posture, to be pivoted from the first position to the second position when the end is moved closer to a support position of the first support portion so that the second support portion is pressed by the end, and to support the wall in the standing posture.

2. The stand of claim 1, wherein the second support portion is configured to be movably supported by the base between the second position and a third position of a standing posture.

3. The stand of claim 1, wherein the base comprises a third support portion configured to support the second support portion at the third position.

4. The stand of claim 2, wherein the second support portion is configured to be movable from the second position to the third position by gravity.

5. The stand of claim 1, wherein the base comprises a fourth support portion configured to support the second support portion of the standing posture in a state in which the second support portion is interposed between the housing and the fourth support portion.

6. The stand of claim 2, wherein the base comprises a fifth support portion configured to pivotably support the second support portion between the first position and the second position, and to movably support the second support portion between the second position and the third position.

7. The stand of claim 1, further comprising a guide portion configured to guide a movement of the end to the support position, and
the second support portion comprises a press portion positioned closer to the support position than a position where the edge is guided by the guide portion, and is configured to be pressed by the end.

8. The stand of claim 7, wherein the second support portion comprises the guide portion configured to guide a movement of the end in a state in which the second support portion is positioned at the first position.

9. The stand of claim 1, wherein the second support portion is configured to be movably supported by the base between the first position and a fourth position of a lying down posture at which the second connector is covered.

10. The stand of claim 6, wherein the second support portion is configured to be movably supported between the first position and a fourth position of a lying down posture at which the second connector is covered, and
the fifth support portion is configured to pivotably support the second support portion between the first position and the second position, to movably support the second support portion between the second position and the third position, and to movably support the second support portion between the first position and the fourth position.

11. An electronic device system comprising:
an electronic device comprising a housing, a display screen, an end of the housing along a periphery of the display screen, and a wall of the housing opposite the display screen; and
a stand configured to support the electronic device,
wherein the stand comprises:
a fixing portion configured to support the end of the housing; and
a movable portion configured to be pivotably supported by the fixing portion at least between a first position of a lying down posture and a second position of a standing posture, to be pivoted from the first position to the second position when the end is moved closer to a support position of the first support portion so that the movable portion is pressed by the end, and to support the wall in the standing posture.
